(19) United States
(12) Patent Application Publication
(10) Pub. No.: US 2020/0244129 A1
(43) Pub. Date: Jul. 30, 2020

(54) COIL WITH COVER STRIP MADE OF HIGH-PERFORMANCE MATERIAL

(71) Applicant: SIEMENS MOBILITY GMBH, MUENCHEN (DE)

(72) Inventor: FLORIAN SCHEMMEL, NUERNBERG (DE)

(21) Appl. No.: 16/632,583

(22) PCT Filed: Jun. 26, 2018
(86) PCT No.: PCT/EP2018/067038

§ 371 Date: Jan. 21, 2020

(30) Foreign Application Priority Data
Jul. 21, 2017 (EP) 17182603.5

(51) Int. Cl. H02K 3/30; H02K 3/34

(52) U.S. Cl. CPC H02K 3/30; H02K 3/40; H02K 3/34

(57) ABSTRACT

A coil of a stator winding of an electric machine has a number of windings that are wound together with a number of layers of a mica strip, onto which, in turn, a number of layers of a cover strip are wound. The cover strip has a sequence of two layers. The two layers are a woven fabric and a film. The fabric is formed of glass fiber or of a first high-performance polymer. The film is formed of a second high-performance polymer.

The present invention relates to a coil of a stator winding of an electric machine,
wherein the coil consists of a number of windings which are wound together with a number of layers of a mica strip, onto which, in turn, a number of layers of a cover strip are wound,
wherein the cover strip has a sequence of two layers, wherein these two layers are a woven fabric and a film in each case.

The present invention relates further to an electric machine, wherein the electric machine has a stator and a rotor, wherein the stator has stator slots into which a stator winding is introduced, wherein the stator winding has coils, wherein at least one of the coils is embodied as a coil, as described above.

The present invention relates further to an electric drive, wherein the drive has an electric machine of this type, a converter and a control facility for the converter, wherein the electric machine can be connected by the control facility by way of the converter to a supply voltage which is greater than 1 kV, in particular greater than 1.5 kV, for instance up to 4.5 kV.

The present invention relates further to a rail vehicle, wherein as a traction drive the rail vehicle has an electric drive of this type.

With electric machines, one or more layers of mica strip is/are applied to the coils of the stator winding for main wall insulation. This takes place, inter alia, in order to increase the moisture resistance and the heat class of the coil. In particular, with electric machines which are used as a traction drive of rail vehicles, this structure is additionally protected against mechanical influences by a layer of woven fabric cover strip. The woven fabric cover strip exclusively has a mechanical protective function. The moisture resistance and the heat class of the main wall insulation are by contrast determined decisively by the number of layers of mica strip. If a specific number of layers of the mica strip does not have the required properties, the number of layers of the mica strip is increased. Alternatively to increasing the number of layers of mica strip, it is also known to inlay additional insulating film strip between the layers of mica strip. The film strips consist in some cases of a polyimide. The film strips are pure films without reinforcement by means of a woven fabric.

In both cases, in other words both with the increase in the number of layers of mica strip and also with the use of film strips between the layers of mica strip, the manufacturing outlay increases and the material and manufacturing costs increase.

With normal electric drives which are not used for traction purposes, it is also known additionally to apply a layer of a combined film-woven fabric cover strip to the layers of mica strip. Both the film and also the woven fabric consist of PET (polyethylene terephthalate). A heat class of at most 180° C. can be achieved with film-woven fabric cover strips of this type.

The object of the present invention consists in providing possibilities by means of which it is possible to create electric machines and drives in a simple and cost-effective manner which are particularly suited to use in traction drives.

The object is achieved by a coil having the features of claim 1. Advantageous embodiments of the coil form the subject matter of the dependent claims 2 to 6.

In accordance with the invention, a coil of the type cited in the introduction is configured in that the woven fabric consists of an optical fiber or of a first high-performance polymer and the film consists of a second high-performance polymer.

It is generally preferred that the woven fabric consists of an optical fiber. If the woven fabric consists of the first high-performance polymer, the first high-performance polymer is preferably aramid. The second high-performance polymer is by contrast preferably polyimide.

The woven fabric is generally facing away from the layers of the mica strip and the film is facing the layers of the mica strip in a manner corresponding hereto. In principle the reverse layer sequence is also possible.

It is possible that the coil is embodied as a flat coil. Alternatively, the coil can be embodied as a three-dimensional form-wound coil.

In the case of a three-dimensional form-wound coil, in principle it is possible to apply the layers of mica strip after the molding process of the coil. For manufacturing reasons, it is however considerably easier if the coil is firstly wound as a flat coil, is then wound with the layers of the mica strip and the layers of the cover strip and is only then molded to form the three-dimensional form-wound coil. In this case, the layers of the mica strip one below the other and/or the layers of the cover strip one below the other exhibit displacements against each other, such as are produced by a process of this type (in other words a molding after the winding with the layers of mica strip and cover strip).

The object is also achieved by an electric machine having the features of claim 7. In accordance with the invention, with an electric machine of the type cited in the introduction, at least one of the coils is embodied according to the invention.

The object is also achieved by an electric drive having the features of claim 8. In accordance with the invention the electric machine of the electric drive is embodied according to the invention.

The object is further achieved by a rail vehicle having the features of claim 9. In accordance with the invention, the rail vehicle has an inventive electric drive as a traction drive.

The properties, features and advantages of this invention described above as well as the manner in which they are achieved will become clearer and more comprehensible in conjunction with the following description of the exemplary embodiments, which are explained in more detail in conjunction with the drawings, which show, in a schematic representation:

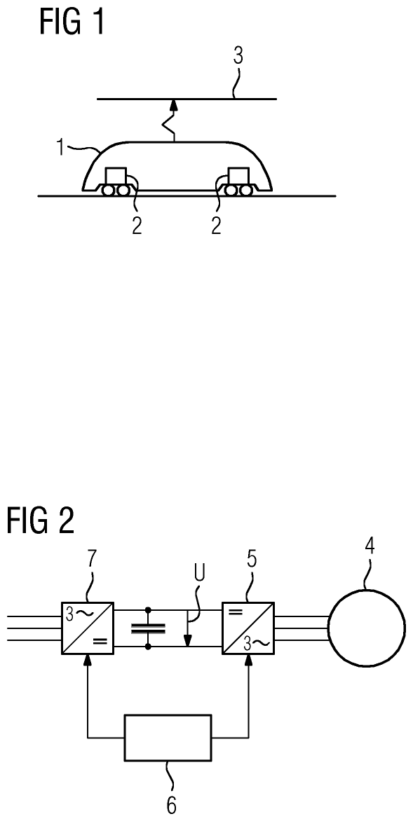

FIG. 1 a rail vehicle,

FIG. 2 an electric drive,

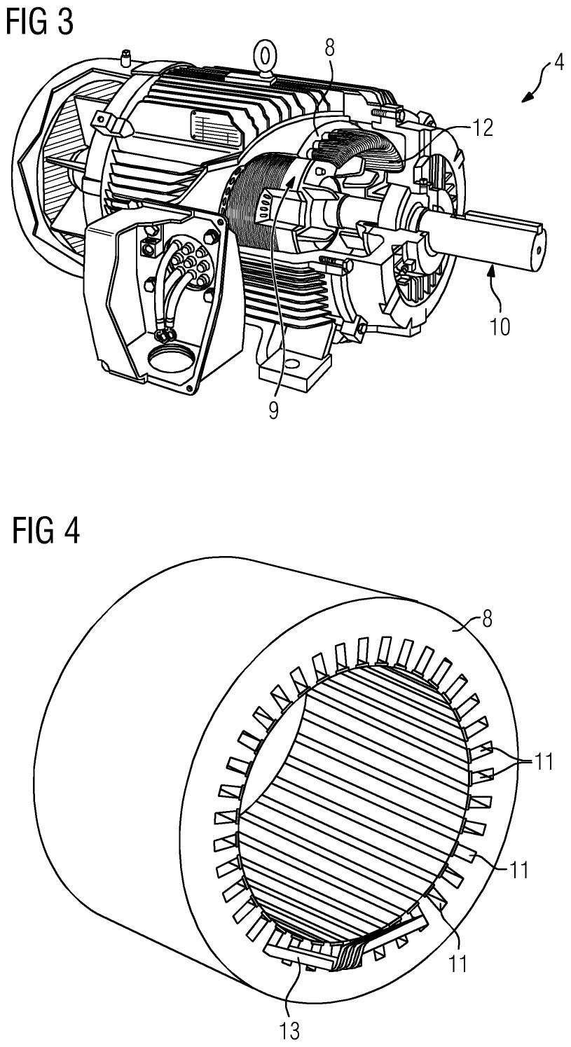

FIG. 3 an electric machine,

FIG. 4 a stator of an electric machine and a coil,

FIG. 5 a cross-section through a coil,

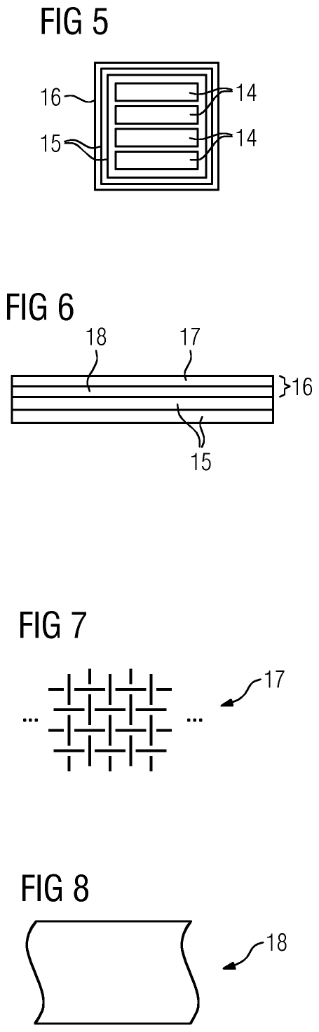

FIG. 6 a sequence of layers of strips,

FIG. 7 a top view onto a top side of a cover strip,

FIG. 8 a top view onto a bottom side of a cover strip,

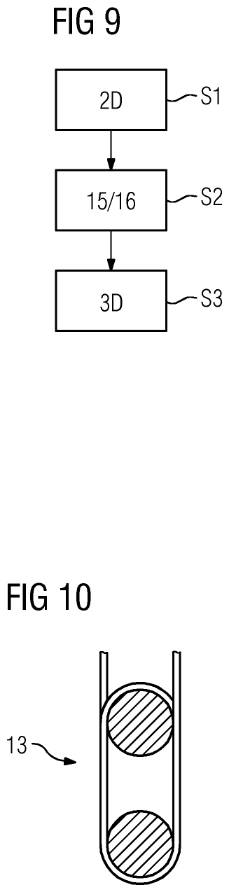

FIG. 9 a flow chart and

FIG. 10 a flat coil.

According to FIG. 1, a rail vehicle 1 (for instance an electric locomotive) has at least one traction drive 2. In accordance with FIG. 1, the traction drive 2 is supplied with electrical energy by way of an overhead contact line 3. Another type of supply is also conceivable, however, by way of a diesel drive, which drives an electric generator, for instance.

The traction drive 2 is one example of an electric drive. In conjunction with the traction drive 2, the present invention is explained in more detail below. The electric drive could also be used for other purposes, however. The term “drive” and furthermore the reference character 2 are therefore used only generally below.

According to FIG. 2 the electric drive 2 has an electric machine 4, a converter 5 and a control facility 6 for the converter 5. In many cases a rectifier 7 is further preassigned to the converter 5. This is not absolutely necessary, however. The electric machine 4 can be connected by the control facility 6 by way of the converter 5 to a supply voltage U. If the rectifier 7 is present and controllable, control of the rectifier 7 generally likewise takes place by means of the control facility 6.

The supply voltage U, in other words that voltage which is applied to the motor terminals of the electric machine 4, often greater than 1 kV. It can even be bigger than 1.5 kV, for instance between 2 kV and 3 kV. In some instances it may amount to 4.5 kV.

According to FIG. 3 the electric machine has a stator 8 and a rotor 9. The rotor 9 is arranged in a torsion-resistant manner on a rotor shaft 10, which for its part can be rotated about an axis of rotation. According to FIGS. 3 and 4 the stator 8 has stator slots 11. A stator winding 12 (see FIG. 3) is introduced into the stator slots 11. The stator winding 12 has coils 13 (see FIG. 4), wherein in FIG. 4 for the sake of clarity only one of the coils 13 is shown.

The embodiment of the coil 13 is the actual subject matter of the present invention.

According to FIG. 5 the coil 13 consists of a number of windings 14. The windings 14 typically consist of copper. In any case, the windings 14 are provided with an electric insulation, not shown separately, for instance a protective paint. The number of windings 14 can be dependent on requirements. The number of four windings 14 shown in FIG. 5 is purely exemplary.

According to FIG. 5, the windings 14 are wound, namely not individually, but instead together, with a number of layers of a mica strip 15. The number of layers of the mica strip 15 can be 1. It is often greater than 1. The number of two layers shown in FIG. 5 is purely exemplary. A number of layers of a cover strip 16 is wound onto the layers of mica strip 15, precisely onto the outermost layer of mica strip 15. The number of layers of the cover strip 16 can be greater than 1. However, generally only one layer of cover strip 16 is wound. The cover strip 16 is generally the outermost layer of the finished coil 13. After winding the coil 13 with the cover strip 16, the finished coil 13 is therefore inserted into the stator 9 or more precisely into two of the stator slots 11.

In the case of the embodiment of the coil 13 as a form-wound coil, the mica strip 15 should have the highest possible flexibility and the lowest possible static friction coefficient between the top side and the bottom side. In particular, the bending strength according to IEC EN ISO 8295 (version 2004) should lie below 50 N/m. The static friction coefficient (defined in the same standard) should be below 0.7. Examples of suitable mica strips are RikaFibrel E364N and RikaFibrel E464N from the Nippon Rika Group.

According to FIGS. 6 to 8 the cover strip 16 is embodied as a laminate, which has a sequence of two layers 17, 18.

These two layers 17, 18 are woven fabric 17 and a film 18 in each case. The cover strip 16 does not contain further component parts. The film 18 therefore borders the woven fabric 17 directly. The woven fabric 17 is generally facing away from the layers of the mica strip 15, and corresponding hereto the film 18 is facing the layers of the mica strip 15. However, in principle, the reverse sequence of woven fabric 17 and film 18 is also possible.

The woven fabric 17 preferably consists of an optical fiber. Alternatively, it can consist of a first high-performance polymer. The first high-performance polymer can be polyimide, but is preferably an aramid, in particular a meta (m) aramid or a para (p) aramid. The film 18 consists of a second high-performance polymer. The second high-performance polymer can be an aramid, in particular a meta (m) aramid or a para (p) aramid. The second high-performance polymer is preferably a polyimide. One example of a suitable cover strip 16 is Voltaflex GK2797 from Isovolta AG.

It is possible for the coil 13 to be an essentially flat coil, however. The coil 13, as identifiable in FIG. 4, is often embodied as a three-dimensional form-wound coil.

In the case of the embodiment as a form-wound coil, it is possible to apply the layers of the mica strip 15 and the layers of the cover strip 16 after molding the coil 13 to form the form-wound coil. According to the display in FIG. 9, a flat coil is preferably firstly wound in a step S1, however. This is indicated in step S1 by the designation “2D”. The flat coil is shown purely by way of example in FIG. 10. Subsequently in a step S2, the layers of mica strip 15 and cover strip 16 are applied to the flat coil, in other words before deformation to form the form-wound coil. This is indicated in step S2 by the designation “15, 16”. In a step S3, the already wound flat coil is only then molded to form the three-dimensional form-wound coil. This is indicated in step S3 by the designation “3D”.

With the molding process (step S3) the layers of the mica strip 15 one below the other and/or the layers of the cover strip 16 one below the other displace against each other. In some instances, the innermost layer of the cover strip 16 which borders the outermost layer of the mica strip 15 also displace against one another. The displacements are a constructive feature of the coils 13 which results due to the manufacturing process.

In summary, the present invention relates to the following facts:

A coil 13 of a stator winding 12 of an electric machine 4 consists of a number of windings 14 which are wound together with a number of layers of a mica strip 15, upon which, in turn, a number of layers of a cover strip 16 are wound. The cover strip 16 has a sequence of two layers 17, 18. These two layers 17, 18 are a woven fabric 17 and a film 18 in each case. The woven fabric 17 consists of an optical fiber or of a first high-performance polymer. The film 18 consists of a second high-performance polymer.

The present invention has many advantages. In particular, on account of the embodiment of the cover strip 16 as a combination of a woven fabric 17 and a film 18, the moisture resistance and the temperature index are improved without requiring an additional layer of mica strip 15. Furthermore, the mechanical protection is also improved. By virtue of the materials used, a heat class of 200° C. or more can be reached.

Although the invention has been illustrated and described in greater detail on the basis of the preferred exemplary embodiment, the invention is not limited by the disclosed examples and other variations may be derived herefrom by the person skilled in the art without leaving the scope of protection of the invention.

1-9. (canceled)

10. A coil of a stator winding of an electric machine, the coil comprising:
a plurality of windings that are commonly wound with a number of layers of a mica strip;
a number of layers of a cover strip wound onto said layers of the mica strip;
said cover strip having a sequence of two layers, with one of said two layers being a woven fabric and another of said two layers being a film;
said woven fabric being formed of optical fibers or of a first high-performance polymer, and said film being a second high-performance polymer.

11. The coil according to claim 10, wherein said first high-performance polymer is an aramid.

12. The coil according to claim 11, wherein said second high-performance polymer is a polyimide.

13. The coil according to claim 10, wherein said second high-performance polymer is a polyimide.

14. The coil according to claim 10, wherein said woven fabric is disposed on a side facing away from said layers of said mica strip and said film is disposed on a side facing said layers of said mica strip.

15. The coil according to claim 10 embodied as a three-dimensional form-wound coil.

16. The coil according to claim 15, wherein said layers of said mica strip, one below another, and/or said layers of said cover strip, one below another, are displaceable relative to one another, enabling said layers to move relative to one another when the coil is firstly wound as a flat coil, subsequently wound with said layers of said mica strip and said layers of said cover strip, and subsequently molded to form the three-dimensional form-wound coil.

17. An electric machine, comprising:
a stator and a rotor;
said stator being formed with stator slots and having a stator winding introduced in said stator slots;
said stator winding having coils, with at least one of said coils being a coil according to claim 10.

18. An electric drive, comprising
an electric machine according to claim 17;
a converter and a controller for said converter;
said controller being configured to connect said electric machine by way of said converter to a supply voltage which is greater than 1 kV.

19. The electric drive according to claim 18, wherein the supply voltage for said electric machine is greater than 1.5 kV.

20. The electric drive according to claim 18, wherein the supply voltage for said electric machine is greater than 1.0 kV and up to 4.5 kV.

21. A rail vehicle, comprising a traction drive being an electric drive according to claim 18.
